(19) United States
(12) Patent Application Publication
(10) Pub. No.: US 2026/0029062 A1
(43) Pub. Date: Jan. 29, 2026

(54) FLOW PATH FORMING DEVICE

(71) Applicant: DENSO CORPORATION, Kariya-city (JP)

(72) Inventor: Shinji NODA, Kariya-city (JP)

(21) Appl. No.: 19/348,318

(22) Filed: Oct. 2, 2025

Related U.S. Application Data
(63) Continuation of application No. PCT/JP2024/009134, filed on Mar. 8, 2024.

(30) Foreign Application Priority Data
Apr. 7, 2023 (JP) 2023-062945

(51) Int. Cl. F16K 27/10; F01P 7/14

(52) U.S. Cl. CPC F16K 27/10; F01P 7/14; F01P 2007/146

(57) ABSTRACT

A flow path forming device in which a fluid flows includes three or more components. The three or more components include a first component, a second component and a third component. The first component and the second component form a flow path within which the fluid flows. The third component is attached to the first component and the second component. The first component includes a first joint face joined to the second component. The second component includes a second joint face joined to the first joint face. The second component is joined to the first component by the second joint face being joined to the first joint face. The third component is attached to the first component and the second component across a joint interface where the first joint face and the second joint face are joined to each other.

### CROSS REFERENCE TO RELATED APPLICATIONS

The present application is a continuation application of International Patent Application No. PCT/JP2024/009134 filed on March 8, 2024, which designated the U.S. and claims the benefit of priority from Japanese Patent Application No.2023-062945 filed on April 7, 2023. The disclosures of all the above applications are incorporated herein.

### TECHNICAL FIELD

The present disclosure relates to a flow path forming device.

### BACKGROUND

Conventionally, a pump device with a multi-way valve is adopted in thermal management systems in vehicles.

### SUMMARY

According to at least one embodiment of the present disclosure, a flow path forming device in which a fluid flows includes three or more components. The three or more components include a first component, a second component and a third component. The first component and the second component form a flow path within which the fluid flows. The third component is attached to the first component and the second component. The first component includes a first joint face joined to the second component. The second component includes a second joint face joined to the first joint face. The second component is joined to the first component by the second joint face being joined to the first joint face. The third component is attached to the first component and the second component across a joint interface where the first joint face and the second joint face are joined to each other.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a top view of a flow path forming device according to a first embodiment.

FIG. 2 is a side view of the flow path forming device according to the first embodiment.

FIG. 3 is a top view of the flow path forming device before securing of a valve to the flow path forming device according to the first embodiment.

FIG.4 is a side view of the flow path forming device before the securing of the valve to the flow path forming device according to the first embodiment.

FIG.5 is a schematic view illustrating means for securing the valve to a casing according to the first embodiment.

FIG. 6 is an enlarged view of a portion VI of FIG. 5.

FIG.7 is a view illustrating a distance between valve holes and a distance between case holes.

FIG.8 is an enlarged view of a portion VIII of FIG. 7.

FIG.9 is a side view illustrating a comparative example where a valve cannot be attached to a casing across a joint interface.

FIG. 10 is a schematic view illustrating means for securing a valve to a casing according to a second embodiment.

FIG. 11 is a side view of a flow path forming device according to a third embodiment.

FIG. 12 is a diagram illustrating sizes of a claw part and a fitting part.

### DETAILED DESCRIPTION

According to a comparative example, a pump device with a multi-way valve is adopted in thermal management systems in vehicles. In the pump device of the comparative example, a flow path forming device includes an integrated plate body with multiple flow paths, a first endplate fixed and connected to one face of the integrated plate body, and a second endplate fixed and connected to the other face of the integrated plate body. The first endplate is connected to a multi-way valve. The second endplate is connected to a three-way proportional valve. As a result, the flow path forming device can allow a fluid to flow into or out of the multi-way valve or the three-way proportional valve.

In case where a flow path forming device includes multiple components and some of the multiple components are joined, a joint interface of the components is subjected to loads, such as a weight of a joined component itself, a weight of another component attached to the joined component, and a weight of a fluid flowing in the device. When the flow path forming device is installed in a vehicle, the joint interface of the components is further subjected to loads due to vehicle vibration. Based on the detailed examination by the inventor, it has been found that the loads applied to the joint interface can be a factor leading to the breakage of the joint interface. In contrast to the comparative example, according to the present disclosure, a flow path forming device is capable of preventing a joint interface of a joined component from breaking.

According to an aspect of the present disclosure, a flow path forming device in which a fluid flows includes three or more components. The three or more components include a first component, a second component and a third component. The first component and the second component form a flow path within which the fluid flows. The third component is attached to the first component and the second component. The first component includes a first joint face joined to the second component. The second component includes a second joint face joined to the first joint face. The second component is joined to the first component by the second joint face being joined to the first joint face. The third component is attached to the first component and the second component across a joint interface where the first joint face and the second joint face are joined to each other.

Accordingly, since a strength of the joint interface, at which the first component and the second component are joined to each other, is improved due to the third component attached across the joint interface, the overall rigidity of the flow path forming device can be improved. As a result, even if loads that separate the first component and the second component at the joint interface occurs, the occurrence of breakage at the joint interface can be prevented.

Hereinafter, embodiments of the present disclosure will be described with reference to the drawings. In the following embodiments, components are the same as or equivalent to those described in the preceding embodiments are denoted by the same reference numerals, and a description of the same or equivalent components may be omitted. In addition, when only a part of the components is described in an embodiment, the components described in the preceding embodiment can be applied to the other parts of the components. The following embodiments may be partially combined with each other, even if such a combination is not explicitly described, as long as there is no disadvantage associated with such a combination.

### First Embodiment

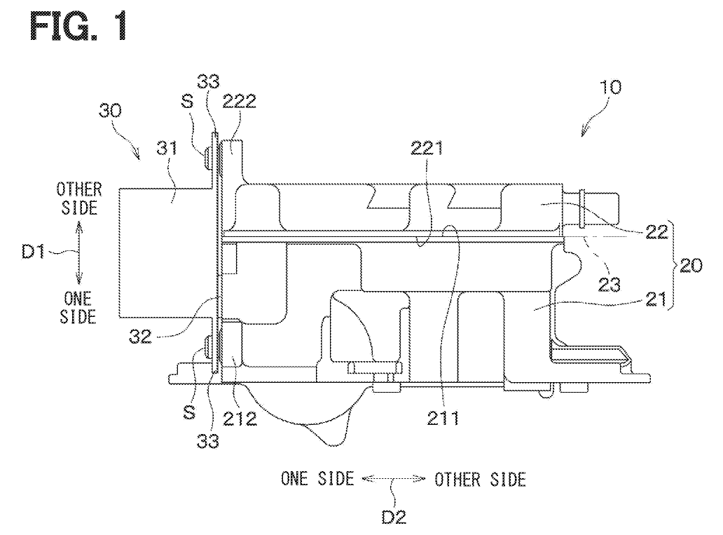

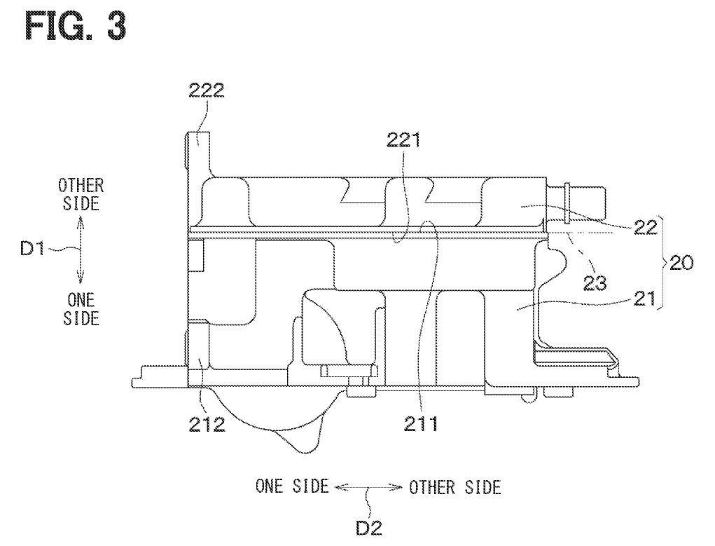

The present embodiment will be described with reference to FIGS. 1 to 9. A flow path forming device 10 of the present disclosure is applicable to a fluid control system installed in, for example, an electric automobile that is a vehicle. The fluid control system is a heat distribution system that appropriately distributes heat generated by a refrigeration cycle and heat generated by various heat-generating devices to various devices that require heat, via a fluid that serves as a heat transfer medium. The flow path forming device 10 is used for guiding the fluid to the various devices that require heat. The fluid flowing within the flow path forming device 10 is a coolant. The coolant may be an antifreeze, but it may be a liquid containing water other than the antifreeze.

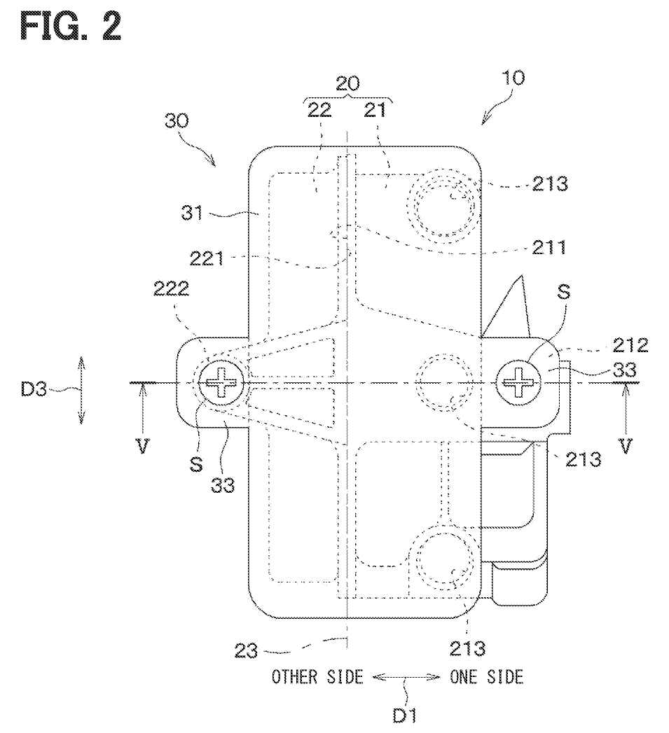

As illustrated in FIGS. 1 and 2, the flow path forming device 10 includes a casing 20 and a valve 30. The casing 20 has a hollow shape and is a manifold forming a flow path through which the fluid flows. The casing 20 is formed by, for example, resin molding. There is an unillustrated flow path inside the casing 20, and the fluid can flow into the valve 30 from the flow path of the casing 20 and flow out from the valve 30 to the flow path of the casing 20.

The casing 20 includes a first case 21 and a second case 22, and the first case 21 and the second case 22 are assembled in a predetermined assembly direction. The valve 30 is attached to a predetermined section of the casing 20 in a direction different from the assembly direction in which the first case 21 and the second case 22 are assembled. The flow path forming device 10 in the present embodiment includes the first case 21, the second case 22, and the valve 30. In FIG. 2, in order to make a positional relationship among the first case 21, the second case 22, and the valve 30 easier to be understood, parts of the first case 21 and the second case 22 that are positioned behind the valve 30 are indicated with dashed lines. In the present embodiment, the first case 21 corresponds to a first component, the second case 22 corresponds to a second component, and the valve 30 corresponds to a third component.

The first case 21 has a hollow shape with a bottom and has an opening facing away from the bottom. As illustrated in FIGS. 1 to 4, the first case 21 includes a first joint face 211 joined to the second case 22, a first case attachment section 212 to which the valve 30 is attached, and three flow-path insertion sections 213 where flow-path sections 32 of the valve 30, described later, are inserted.

The second case 22 has a hollow shape with a bottom and has an opening facing away from the bottom. The second case 22 includes a second joint face 221 joined to the first case 21, and a second case attachment section 222 where the valve 30 is attached.

The first joint face 211 is flat and has the opening of the first case 21 opposite the bottom of the first case 21. The second joint face 221 is flat and has the opening opposite the bottom of the second case 22. Additionally, the casing 20 is assembled by joining the first joint face 211, which has the opening of the first case 21, and the second joint face 221, which has the opening of the second case 22.

A joint interface 23 is defined as a surface indicating a boundary between the first case 21 and the second case 22 in a state where the first joint face 211 and the second joint face 221 are joined to each other. The casing 20 includes the joint interface 23 generated by the joining of the first joint face 211 and the second joint face 221. Since the casing 20 is assembled by the joining of the first face 211 and the second face 221, the flow path inside the casing 20 is sealed. In other words, the first joint case 21 and the second joint case 22 form the flow path through which the fluid flows. The first joint face 211 and the second joint face 221 can be joined by, for example, fusing, adhesion, or welding.

Hereinafter, as illustrated in FIG. 1 and the like, a direction in which the first case 21 and the second case 22 are assembled is referred to as a first direction D1, a direction perpendicular to the first direction D1 is referred to as a second direction D2. The first direction D1 is a direction crossing the joint interface 23 and is specifically perpendicular to the joint interface 23. The first direction D1 corresponds to a surface normal direction. Additionally, as illustrated in FIG. 2 and the like, a direction perpendicular to both the first direction D1 and the second direction D2 is referred to as a third direction D3.

In the present embodiment, for example, an example will be described where the flow path forming device 10 is installed in a vehicle so that the third direction D3 becomes a vertical direction, i.e., an up-down direction. The orientation of the flow path forming device 10 is one example. The orientation of the flow path forming device 10 with being installed in a vehicle is not limited to the orientation illustrated in FIGS. 1 and 2, and the like.

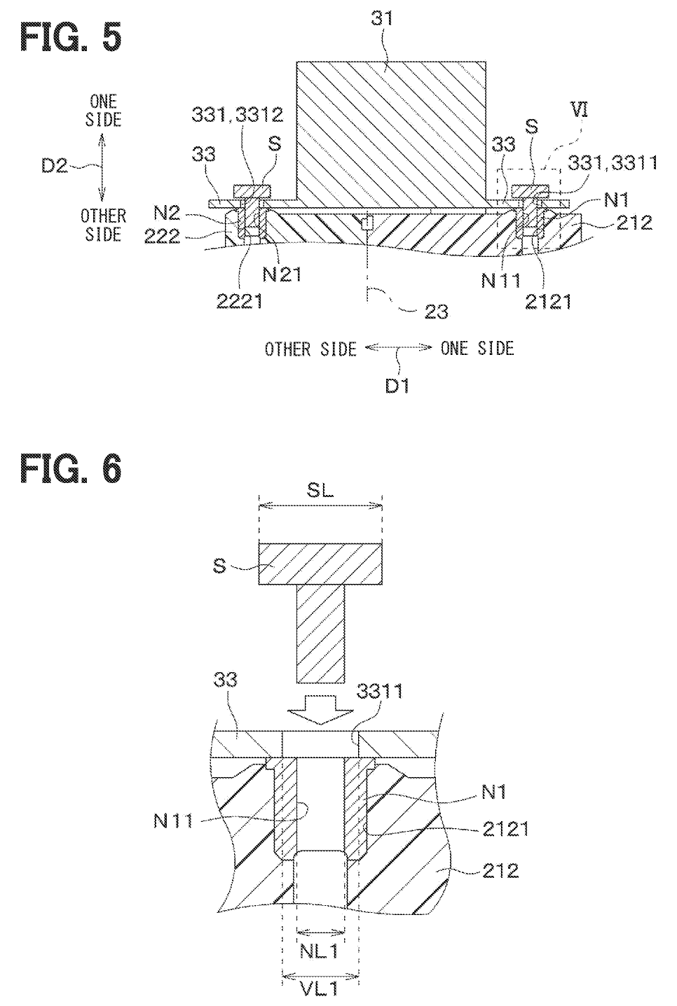

The first case attachment section 212 of the first case 21 protrudes from one side of the first case 21 in the first direction D1. As illustrated in FIG. 5, the first case attachment section 212 includes a first case hole 2121 in which a screw S is inserted. The screw S is an attachment member for attachment of the valve 30 to the first case 21. In the first case hole 2121, a first nut N1 is inserted to be fastened to the screw S. The first nut N1 includes a first screw hole N11 with threaded grooves on an inner periphery, into which the screw S is screwed.

One of the three flow-path insertion sections 213 is an inlet allowing the fluid to flow in the flow path inside the casing 20, and the remaining two are outlets allowing the fluid to flow out of the flow path from the inside of the casing 20 to the outside of the casing 20. The three flow-path insertion sections 213 have insertion openings in which the flow-path sections 32 of the valve 30 can be inserted. Each of the insertion openings has a circular shape. The flow-path sections 32 are inserted in the three flow-path insertion sections 213 and the valve 30 is connected to the three flow-path insertion sections 213.

The second case attachment section 222 of the second case 22 protrudes from the other side of the second case 22 in the first direction D1. The second case attachment section 222 is positioned to be plane-symmetric to the first case attachment section 212 of the first case 21, with the joint interface 23 serving as the plane of symmetry. As illustrated in FIG. 5, the second case attachment section 222 includes a second case hole 2221 in which a screw S for securing the valve 30 to the second case 22 is inserted. In the case hole 2221, a second nut N2 is inserted to be fastened to the screw S. The second nut N2 includes a second screw hole N21 with threaded grooves on an inner periphery, into which the screw S is screwed.

Each central axis of the first case hole 2121, the first screw hole N11, the second case hole 2221, and the second screw hole N21 extends in the second direction D2, which crosses the first direction D1. The valve 30 is fastened to each of the first case 21 and the second case 22 by screws S being screwed in each of the first nut N1 and the second nut N2.

The valve 30 forms a flow path together with the casing 20 and switches the flow path of the fluid flowing through the fluid control system. The valve 30 may be constituted of, for example, a multi-way valve including unillustrated multiple inlets and outlets for the fluid. The valve 30 includes a valve body 31, the three flow-path sections 32 that are tube-shaped and protrude from the valve body 31, and two valve attachment sections 33 for an attachment of the valve 30 to the casing 20.

The valve body 31 is a casing forming an outer shell of the valve 30, and has a hollow shape. The valve body 31 includes the flow path inside itself and accommodates, for example, an unillustrated valve element that switches the flow path in the valve body 31.

One of the three flow-path sections 32 allows the fluid to flow in the valve body 31, and the remaining two allow the fluid that is flowed in the valve body 31 to flow out to the outside of the valve body 31. Since the three flow-path sections 32 are inserted, respectively, in the three flow-path insertion sections 213 of the first case 21, and the flow path in the valve body 31 communicates with the flow path in the casing 20, the valve 30 forms the flow path together with the casing 20.

The valve attachment sections 33, to which the screws S for the attachment of the valve 30 to the casing 20 are fastened, have rib shapes and protrude from opposite sides of the valve body 31 in the first direction D1. The valve attachment sections 33 include, for example, valve holes 331 thorough which the screws S are inserted. Hereinafter, a valve hole 331 of a valve attachment section 33 protruding from one side of the valve body 31 in the first direction D1 is referred to as a first valve hole 3311. Another valve hole 331 of a valve attachment section 33 protruding from the other side of the valve body 31 in the first direction D1 is referred to as a second valve hole 3312. Each central axis of the first valve hole 3311 and the second valve hole 3312 extends in the second direction D2 crossing the first direction D1. The first valve hole 3311 and the second valve hole 3312 correspond to a third screw hole.

The first valve hole 3311 is positioned to face the first case hole 2121 of the first case 21 in the second direction D2. Additionally, the second valve hole 3312 is positioned to face the second case hole 2221 of the second case 22 in the second direction D2. Specifically, the central axis of the first valve hole 3311 is aligned with the central axis of the first screw hole N11 of the first nut N1 that is inserted into the first case hole 2121. The central axis of the second valve hole 3312 is aligned with the central axis of the second screw hole N21 of the second nut N2 that is inserted into the second case hole 2221.

The screw S is inserted through the first valve hole 3311 to be inserted into the first case hole 2121. Additionally, the other screw S is inserted through the second valve hole 3312 to be inserted into the second case hole 2221. As a result, the valve 30 is attached to the first case 21 and the second case 22 on one side of the casing 20 in the second direction D2.

Specifically, as illustrated in FIGS. 1 and 2, the valve 30 is attached to both the first case 21 and the second case 22 on the one side of the casing 20 in the second direction D2 with the screws S. In other words, the valve 30 is attached to the casing 20 across the joint interface 23 between the first joint face 211 of the first case 21 and the second joint face 221 of the second case 22 being joined each other.

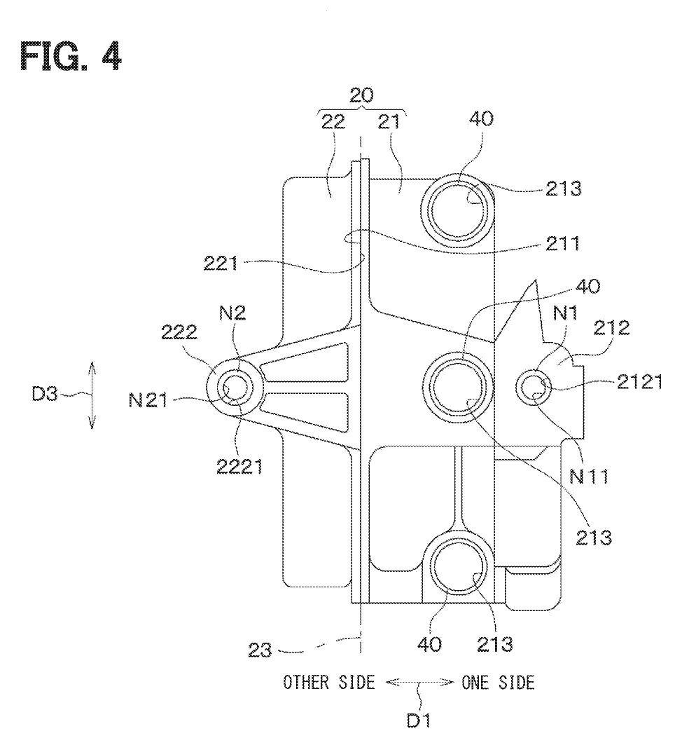

Additionally, the flow path forming device 10 of the present embodiment includes the flow-path sections 32 inserted in the flow-path insertion sections 213, and the valve 30 is attached to the casing 20. As illustrated in FIG. 4, O-rings 40 are provided between the outer peripheries of the flow-path sections 32 and the inner peripheries of the flow-path insertion sections 213, as sealing members to prevent the leakage of fluid. The O-rings 40 are arranged with being pressed and elastically deformed between the outer peripheries of the flow-path sections 32 and the inner peripheries of the flow-path insertion sections 213.

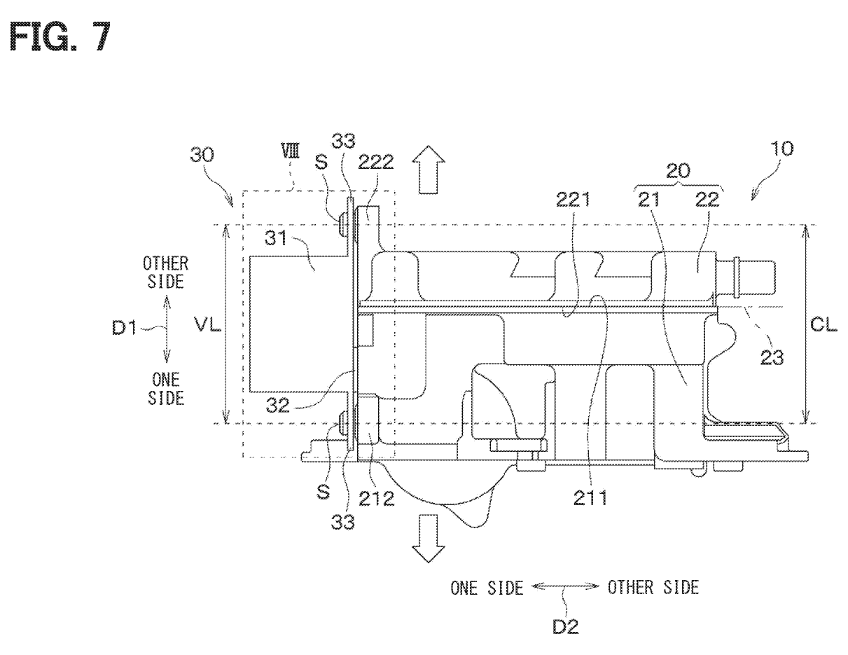

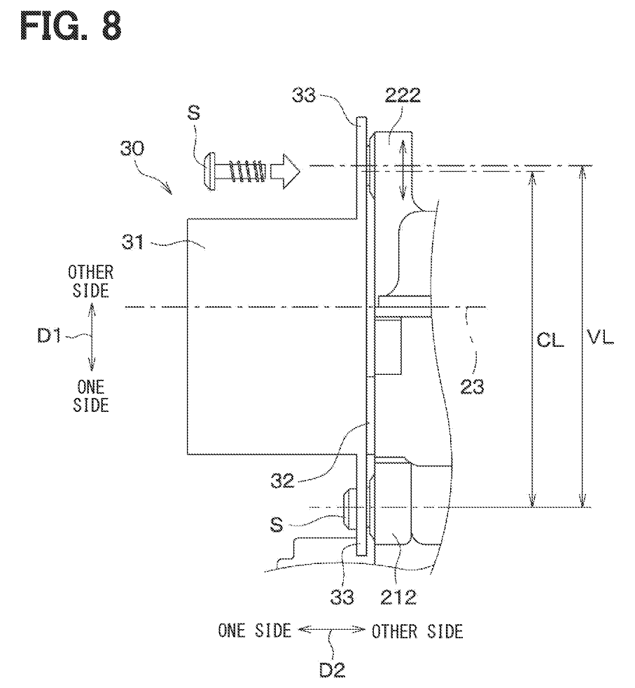

Here, in the flow path forming device 10 of the present embodiment, as illustrated in FIG. 6, a first valve diameter VL1, which is an inner diameter of the first valve hole 3311, is larger by a predetermined amount than a first nut diameter NL1, which is an inner diameter of the first screw hole N11 of the first nut N1. Although not illustrated, an inner diameter of the second valve hole 3312 is larger by the predetermined amount than an inner diameter of the second screw hole N21 of the second nut N2. The reasons why the first valve diameter VL1 is larger than the first nut diameter NL1 and the inner diameter of the second valve hole 3312 is larger than the inner diameter of the second screw hole N21 will be described with reference to FIGS. 7 and 8.

When the first joint face 211 and the second joint face 221 are joined to form the casing 20, a distance between the center of the first screw hole N11 in the first case 21 and the center of the second screw hole N21 in the second case 22 may deviate from a predetermined design value. Additionally, positions of the first screw hole N11 and the second screw hole N21 may deviate from predetermined design positions. Hereinafter, a distance between the center of the first screw hole N11 and the center of the second screw hole N21 is referred to as a case hole distance CL.

Factors that cause the case hole distance CL to deviate from the design value include errors due to, for example, a design error such as surface roughness and flatness of the first joint face 211 and the second joint face 221, and an assembly error occurred during manufacturing. Factors that cause the positions of the first screw hole N11 and the second screw hole N21 to deviate from the design positions include errors due to, for example, a design error of the first case attachment section 212 and the second case attachment section 222, and a manufacturing error occurred during tapping of the first screw hole N11 and the second screw hole N21. For example, when the first joint face 211 and the second joint face 221 are joined by welding, there may be variations in a melted amount of the first joint face 211 and the second joint face 221 during the welding. The variations in the melted amount of the first joint face 211 and the second joint face 221 may cause the case hole distance CL and the positions of the first screw hole N11 and the second screw hole N21 to deviate from the design value and the design positions. As above, the deviation in the case hole distance CL and the deviation in the positions of the first screw hole N11 and the second screw hole N21 are based on errors in the joint interface 23 formed by the first joint face 211 and the second joint face 221.

On the other hand, positions of the first valve hole 3311 and the second valve hole 3312 of the valve 30 are set so that the central axis of the first valve hole 3311 is aligned with the central axis of the first screw hole N11 and the central axis of the second valve hole 3312 is aligned with the central axis of the second screw hole N21. Additionally, a valve hole distance VL, which is a distance between the center of the first valve hole 3311 and the center of the second valve hole 3312, is set to be equal to the design value of the case hole distance CL.

However, the valve hole distance VL may deviate from its design value that is set to be equal to the design value of the case hole distance CL, due to, for example, a design error of the valve 30. Additionally, due to, for example, the design error in the valve 30, the central axis of the first valve hole 3311 may not be aligned with the central axis of the first screw hole N11, or the central axis of the second valve hole 3312 may not be aligned with the central axis of the second screw hole N21.

As a result, if the case hole distance CL or the valve hole distance VL deviate from their predetermined design values, the case hole distance CL may not coincide with the actual valve hole distance VL. Additionally, if positions of the first screw hole N11 and the first valve hole 3311 deviate from their predetermined design positions, the central axis of the first valve hole 3311 may not be aligned with the central axis of the first screw hole N11. If positions of the second screw hole N21 and the second valve hole 3312 deviate from their predetermined design positions, the central axis of the second valve hole 3312 may not be aligned with the central axis of the second screw hole N21.

For example, it is assumed that the actual case hole distance CL becomes shorter than the predetermined design value due to a design error of the joint interface 23 when the first joint face 211 and the second joint face 221 are joined to each other and constitute the casing 20. On the other hand, it is assumed that the actual valve hole distance VL of the valve 30 becomes longer than the predetermined design value due to a design error of the valve 30. In such assumptions, as shown in FIG. 8, the valve hole distance VL is longer than the case hole distance CL.

Here, it is further assumed that the inner diameter of the first valve hole 3311 is approximately equal to the inner diameter of the first screw hole N11, and the inner diameter of the second valve hole 3312 is approximately equal to the inner diameter of the second screw hole N21.

In this case, first, the valve 30 is attached to the first case 21 by inserting and screwing the screw S into the first valve hole 3311 and the first screw hole N11. Then, as shown in FIG. 8, the second valve hole 3312 deviates from a position of the second screw hole N21 in the first direction D1 away from the joint interface 23. In this state, if the valve 30 is attached to the second case 22 by inserting and screwing the screw S into the second valve hole 3312 and the second screw hole N21, loads illustrated as hollow arrows in FIG. 7 may be applied to the joint interface 23. The loads may pull the first case 21 and the second case 22 apart.

Alternatively, the valve 30 may be attached to the first case 21 and the second case 22 by screwing in a state where the central axes of the first valve hole 3311 and the first screw hole N11 are not aligned, or the central axes of the second valve hole 3312 and the second screw hole N21 are not aligned. In this case, the loads applied to the joint interface 23 may occur in not only the first direction D1, but also random directions crossing the first direction D1, such as the third direction D3.

Such loads may cause the first joint face 211 and the second joint face 221 to be separated from each other, resulting in breakage of the joint interface 23.

In contrast to these cases, in the flow path forming device 10 of the present embodiment, the first valve diameter VL1 of the first valve hole 3311 is larger than the first nut diameter NL1 of the first screw hole N11, and the inner diameter of the second valve hole 3312 is larger than the inner diameter of the second screw hole N21. Specifically, the first valve diameter VL1 is larger than the first nut diameter NL1 of the first screw hole N11 by an amount corresponding to an estimated error of the joint interface 23. Additionally, the inner diameter of the second valve hole 3312 is larger than the inner diameter of the second screw hole N21 by an amount corresponding to the estimated error of the joint interface 23.

Thus, for example, even if the second valve hole 3312 is deviated from the second screw hole N21 in the first direction D1 and the third direction D3, the screw S can be inserted at a point deviated from the central axis of the second valve hole 3312. As a result, the inner diameter of the second valve hole 3312 set based on the design error of the joint interface 23 is capable of absorbing a deviation between the valve hole distance VL and the case hole distance CL. Therefore, when the valve 30 is attached to the second case 22 with the screw S, it is possible to prevent the loads that pull the first case 21 and the second case 22 apart from being applied to the joint interface 23.

In the case which has been described above, the screw S is inserted into the first valve hole 3311 and the first screw hole N11 to attach the valve 30 to the first case 21, and then the screw S is inserted into the second valve hole 3312 and the second screw hole N21 to fix the valve 30 to the second case 22. However, the same result can be achieved even when the screw S is inserted into the second valve hole 3312 and the second screw hole N21 to attach the valve 30 to the second case 22, and then the screw S is inserted into the first valve hole 3311 and the first screw hole N11 to attach the valve 30 to the first case 21. In other words, even if the first valve hole 3311 is deviated in the first direction D1 and the third direction D3 from the first screw hole N11, the deviation between the valve hole distance VL and the case hole distance CL can be absorbed by the inner diameter of the first valve hole 3311. As described above, the first valve hole 3311 and the second valve hole 3312 serve as mounting adjustment sections that adjust an attachment position of the valve 30, which is attached to the first case 21 and the second case22, in both the first direction D1 and the third direction D3, crossing the first direction D1.

As shown in FIGS. 5 and 6, an outer diameter SL of a head of the screw S is sufficiently larger than the inner diameter of the first valve hole 3311 and the inner diameter of the second valve hole 3312. As a result, the head of the screw S cannot be inserted into the first valve hole 3311 or the second valve hole 3312.

Additionally, in the flow path forming device 10 of the present embodiment, the flow-path sections 32 are inserted into the flow-path insertion section 213, and the valve 30 is attached to the casing 20. For example, if the valve 30 is deviated from a design position in the first direction D1 and is attached to the casing 20 with the screw S, the flow-path sections 32 are deviated in the first direction D1 according to the deviation of the valve 30 and are inserted into the flow-path insertion sections 213.

Thus, each of the O-rings 40 provided between a flow-path section 32 and a flow-path insertion section 213 is elastically deformed unevenly in the first direction D1. The O-rings 40 may deteriorate if the unevenly and elastically deformed state is maintained. The deterioration of the O-rings 40 may decrease sealing performance between the flow-path section 32 and the flow-path insertion section 213, and cause the fluid to leak from between the flow-path section 32 and the flow-path insertion section 213.

In contrast, in the flow path forming device 10 of the present embodiment, the first valve hole 3311 and the second valve hole 3312 can be used to adjust an attachment position of the valve 30 attached to the first case 21 and the second case 22 in the first direction D1.

As a result, the attachment position of the valve 30 is less likely to deviate from the design position. Accordingly, the O-ring 40 is less likely to be unevenly and elastically deformed in the first direction D1. Therefore, the leakage of fluid from between the flow-path section 32 and the flow-path insertion section 213 due to the deterioration of the O-rings 40 can be reduced.

Additionally, for example, when the valve 30 is attached to the casing 20, the flow-path sections 32 can be inserted into the flow-path insertion sections 213 before the valve 30 is attached to the casing 20 with the screw S. In this case, even if the valve hole distance VL and the case hole distance CL do not coincide with each other, the inner diameter of the first valve hole 3311 and the inner diameter of the second valve hole 3312 can absorb the deviation. Thus, the valve 30 can be attached to the casing 20 so that the attachment position of the valve 30 is close to the design position of the valve 30. As a result, the O-rings 40 are less likely to be unevenly deformed in the first direction D1 and in a direction crossing the first direction D1 during the attachment of the valve 30.

As described above, the flow path forming device 10 of the present embodiment includes the first case 21 and the second case 22 that constitute a flow path through which the fluid flows, and the valve 30 attached to the first case 21 and the second case 22. The first case 21 has the first joint face 211 joined to the second case 22. The second case 22 includes the second joint face 221 joined to the first case 21. The second joint face 221 is joined to the first joint face 211. In this way, the second case 22 is joined to the first case 21. The valve 30 is attached to the first case 21 and the second case 22 across the joint interface 23 that is formed by the first joint face 211 and the second joint face 221 joined to each other.

Accordingly, the valve 30, which is attached to the casing 20 across the joint interface 23, can improve a strength of the joint interface 23, which is a section where the first case 21 and the second case 22 are joined to each other, and can improve an overall rigidity of the flow path forming device 10. Even if a load separating the first case 21 and the second case 22 is applied to the joint interface 23, the joint interface 23 can be prevented from being broken.

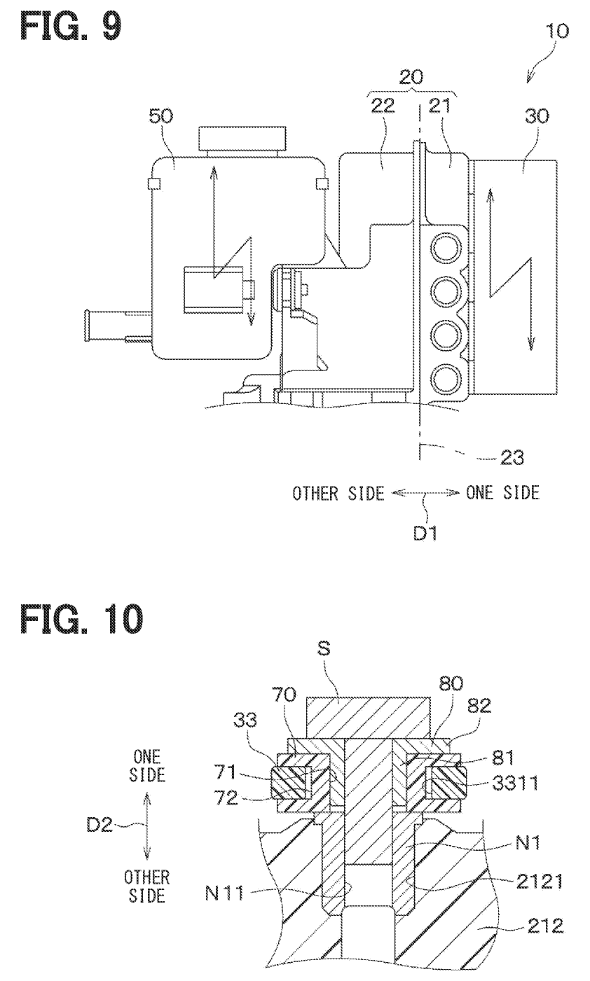

As shown in FIG. 9, if the flow path forming device 10 has a configuration that the valve 30 is not positioned across the joint interface 23 during the securing of the valve 30 to the casing 20, the strength of the joint interface 23 cannot be improved by the attachment of the valve 30. For example, as shown in FIG. 9, the valve 30 is joined and attached only to the first case 21. In this case, a load due to a weight of the valve 30 itself attached to the casing 20 and a load due to a weight of the fluid flowing within the casing 20 and the valve 30 are applied to the joint interface 23. Additionally, when other components, such as a reservoir tank 50 shown in FIG. 9, are further attached to the second case 22, a load due to a weight of these other components is also applied to the joint interface 23.

The flow path forming device 10 of the present embodiment is attached to an electric automobile so that the third direction D3 perpendicular to the first direction D1 is the vertical direction. In this case, the loads applied to the joint interface 23 occurs in the third direction D3, i.e., the vertical direction, due to vibrations during the running of the electric automobile. If there is no part that is attached to the casing 20 across the joint interface 23, the improvement of the strength of the joint interface 23 is difficult.

In contrast, the flow path forming device 10 can improve a strength of the joint interface 23 against the loads applied to the joint interface 23 in the third direction D3 due to the valve 30 attached to the casing 20 across the joint interface 23.

In the present embodiment, an example is described in which the valve 30 is the part attached to the casing 20 across the joint interface 23, but the present disclosure is not limited to this example. Various parts, such as an electric pump, a heat exchanger, and the reservoir tank 50, which can be attached to the casing 20 among components of the fluid control system having the flow path forming device 10, can be adopted as the part attached to the casing 20 across the joint interface 23.

According to the above embodiment, the following advantageous effects can be obtained.

1. The flow path forming device 10 of the above embodiment includes the first valve hole 3311 and the second valve hole 3312 that adjust the attachment position of the valve 30 in the first direction D1 and in the third direction D3 crossing the first direction D1.

As described above, when the first joint face 211 and the second face 221 are joined and constitute the casing 20, the case hole distance CL may deviate from the predetermined design value due to an error of the joint interface 23, such as a design error and an assembly error. Additionally, positions of the first screw hole N11 and the second screw hole N21 may deviate from the predetermined design positions. In this case, when the valve 30 is attached to the first case 21 and the second case 22 based on the design value of the case hole distance CL, a load pulling the first case 21 and the second case 22 apart may applied to the joint interface 23.

As a countermeasure, the flow path forming device 10 allows for adjustment of the attachment position of the valve 30 in the first direction D1 and in the third direction D3 by the first valve hole 3311 and the second valve hole 3312. Thus, even if the case hole distance CL and the positions of the first screw hole N11 and the second screw hole N21 are deviated from the design value and their design positions, the loads caused by the deviation and applied to the joint interface 23 can be reduced. Accordingly, the breakage of the joint interface 23 can be prevented.

2. In the above embodiment, the valve 30 is attached to the first case 21 and the second case 22 with screws S, and includes the valve hole 331 in which one of the screws S is inserted. The first case 21 includes the first nut N1 in the first screw hole N11 in which the screw S inserted through the valve hole 331 is inserted and fastened. The second case 22 includes the second nut N2 in the second screw hole N21 in which another of the screws S inserted through the valve hole 331 is inserted and fastened. Each central axis of the valve hole 331, the first screw hole N11, and the second screw hole N21 extends in the first direction D1. The first valve hole 3311 includes the inner diameter that is set larger than the inner diameter of the first screw hole N11 by a predetermined amount. The second valve hole 3312 includes the inner diameter that is set larger than the inner diameter of the second screw hole N21 by the predetermined amount. The first valve hole 3311 and the second valve hole 3312 include a function that adjust the attachment position of the valve 30 in the first direction D1 and the third direction D3.

Accordingly, even if the case hole distance CL and the positions of the first screw hole N11 and the second screw hole N21 deviate from the design value and positions, the amount of deviation from the design value and positions can be absorbed by the sizes of the first valve hole 3311 and the second valve hole 3312. As a result, even if the case hole distance CL, the position of the first screw hole N11, and the position of the second screw hole N21 deviate from the design value and positions in the first direction D1 and in the third direction D3, the loads applied to the joint interface 23 caused by the deviation can be reduced. Accordingly, the breakage of the joint interface 23 can be prevented.

3. In the above embodiment, the predetermined amount is based on the error of the joint interface 23 where the first joint face 211 and the second joint face 221 are joined to each other.

In other words, the sizes of the first valve hole 3311 and the second valve hole 3312 are defined based on the error of the joint interface 23, such as the design error and the assembly error of the first joint face 211 and the second joint face 221. As a result, the deviation of the case hole distance CL according to the deviation of the joint interface 23 can be absorbed by the sizes of the first valve hole 3311 and the second valve hole 3312.

4. In the above embodiment, the flow path forming device 10 includes the flow-path sections 32 that allow the fluid to flow between the valve 30 and a flow path constituted by the first case 21 and the second case 22. Further, the flow path forming device 10 includes the flow-path insertion sections 213 inserted in the flow-path sections 32, and the O-rings 40 preventing the leakage of the fluid between the flow-path sections 32 and the flow-path insertion sections 213. The flow-path sections 32 are inserted in the flow-path insertion sections 213, thereby the valve 30 being attached to the first case 21.

Accordingly, the valve 30 can be attached to the casing 20 with the flow-path sections 32 forming the flow path. Further, the flow path forming device 10 of the present embodiment can adjust the attachment position of the valve 30 in the first direction D1. Even if the case hole distance CL deviates from the design value, the attachment position of the valve 30 is less likely to be deviated from the design position. Thus, the O-rings 40 between the flow-path sections 32 and the flow-path insertion sections 213 are less likely to be unevenly and elastically deformed in both the first direction D1 and in a direction crossing the first direction D1. Therefore, the deterioration of the O-rings 40 caused by the O-rings 40 remaining in a state of being unevenly and elastically deformed can be reduced. The leakage of the fluid from between the flow-path sections 32 and the flow-path insertion sections 213 due to the deterioration of the O-rings 40 can be reduced.

5. In the above embodiment, the flow path forming device 10 is applied to an electric automobile that is a vehicle. Additionally, a fluid is a coolant.

In a case where the fluid is the coolant, a load due to a weight of the coolant flowing within the casing 20 and the valve 30 is applied to the joint interface 23. Thus, the load applied to the joint interface 23 is likely to be larger than a case where the fluid is a gas. Therefore, when the coolant flows within the flow path forming device 10, a configuration in which the valve 30 is attached to the first case 21 and the second case 22 across the joint interface 23 is preferable.

### Modification of the First Embodiment

In the above first embodiment, an example has been described in which the inner diameter of the first valve hole 3311 is larger than the inner diameter of the first screw hole N11 by the predetermined amount, and the inner diameter of the second valve hole 3312 is larger than the inner diameter of the second screw hole N21 by the predetermined amount. However, the present disclosure is not limited to this example.

For example, as long as the screw S can be inserted, the inner diameter of the first valve hole 3311 may be approximately equal to the inner diameter of the first screw hole N11. Additionally, as long as the screw S can be inserted, the inner diameter of the second valve 3312 may be approximately equal to the inner diameter of the second screw hole N21. Moreover, the inner diameter of the first valve hole 3311 may be larger than the inner diameter of the first screw hole N11 by the predetermined amount while the inner diameter of the second valve hole 3312 is approximately equal to the inner diameter of the second screw hole N21. Further, the inner diameter of the first valve hole 3311 may be approximately equal to the inner diameter of the first screw hole N11 while the inner diameter of the second valve hole 3312 is larger than the inner diameter of the second screw hole N21 by the predetermined amount.

### Second Embodiment

Next, a second embodiment will be described with reference to FIG. 10. The present embodiment is different from the first embodiment in a part of a structure in which a valve 30 is attached to a first case 21 and a second case 22. The other configurations are the same as those of the first embodiment. Therefore, in the present embodiment, portions different from the first embodiment will be mainly described, and description of portions similar to the first embodiment may be omitted.

As shown in FIG. 10, a flow path forming device 10 of the present embodiment includes a bush 70 and a collar 80 provided on the periphery of a screw S. The bush 70 is an elastic section formed of an elastic material such as a resin, and is elastically deformable by an externally applied force. The bush 70 has a hollow cylindrical shape to include an elastic section hole 71 through which the screw S is inserted. The elastic section hole 71 has a central axis extending in a second direction D2 crossing a first direction D1. Additionally, the bush 70 includes a recess 72 located approximately at the center of the outer periphery of the bush 70 in the second direction D2. The recess 72 of the bush 70 is fitted into a first valve hole 3311 of a valve attachment section 33. The recess 72 is formed by the outer periphery of the bush 70 being recessed inward.

The recess 72 of the bush 70 is fitted into the first valve hole 3311. As a result, the elastically deformable bush 70 is positioned between the inner periphery of the first valve hole 3311 and the outer periphery of the screw S. The bush 70 includes a portion that is positioned between one side of the bush 70 in the second direction D2 and the screw S. The bush 70 includes a portion that is positioned between the other side of the bush 70 in the second direction D2 and a first case attachment section 212.

The valve 30 of the present embodiment is attached to the first case 21 and the second case 22 with screws S inserted into elastic section holes 71 of bushes 70.

The collar 80 is formed of a material such as a metal whose rigidity is greater than the bush 70. The collar 80 includes a tube 81 having a cylindrical shape, and an annular section 82 having an annular shape. The annular section 82 protrudes from an end of the tube 81 in a direction extending radially outward from the central axis of the tube 81. The end of the tube 81 faces in the second direction D2 away from the first case attachment section 212.

An inner diameter of the tube 81 is slightly larger than the outer diameter of the screw S, and the screw S can be inserted into the tube 81. The outer diameter of the tube 81 is approximately equal to an inner diameter of the bush 70, and the tube 81 can be inserted into the bush 70. The size of the tube 81 in the second direction D2 is shorter than the size of the bush 70 when the bush 70 is not elastically deformed in the second direction D2.

The annular section 82 has an annular plate shape having an opening at center of the annular section 82, and the annular section 82 has a surface perpendicular to the second direction D2. The opening of the annular section 82 communicates with an internal space of the tube 81.

The collar 80 includes the tube 81 inserted into the bush 70, and the annular section 82 is positioned between the bush 70 and the screw S in the second direction D2.

As described above, the flow path forming device 10 of the present embodiment includes bushes 70. The bushes 70 are formed of an elastic material and include elastic section holes 71 into which the screws S are inserted. Each elastic section hole 71 includes a central axis that extends in the second direction D2 and perpendicular to the first direction D1. The valve 30 is attached to the first case 21 and the second case 22 with the screws S inserted through the elastic section holes 71.

Accordingly, even if a case hole distance CL, and positions of a first screw hole N11 and a second screw hole N21 deviate from their design value and positions in both the first direction D1 and the third direction D3, the bushes 70 are elastically deformed according to these deviations in the first direction D1 and the third direction D3. Thus, the bushes 70 are capable of absorbing the deviations of the case hole distance CL and the positions of the first screw hole N11 and the second screw hole N21 from the design values and positions in the first direction D1 and the third direction D3.

The positions where a first joint face 211 and a second joint face 221 are joined to each other may be deviated in the second direction D2 due to, for example, a design error and an assembly error. For example, a joint position of the first joint face 211 to the second joint face 221 may be deviated from a design position in the second direction D2. The deviation of the first joint face 211 and the second joint face 221 in the second direction D2 is caused by an error of a joint interface 23 formed by the first joint face 211 and the second joint face 221.

In this situation, even if the first joint face 211 and the second joint face 221 are deviated in the second direction D2, the bushes 70 are elastically deformed according to the deviation in the second direction D2. Accordingly, the deviation of the first joint face 211 and the second joint face 221 from the design positions in the second direction D2 can be absorbed by the bushes 70.

As a result, even if the case hole distance CL, and the positions of the first screw hole N11 and the second screw hole N21 are deviated from their design values and positions, or the first joint face 211 and the second joint face 221 are deformed from their design positions, loads applied to the joint interface 23 due to the deviations can be reduced. Accordingly, the breakage of the joint interface 23 can be prevented.

Further, in the present embodiment, when a coolant flows within a casing 20, the casing 20 may absorb a heat of the coolant flowing through flow paths in the casing 20 and may be expanded. In that case, the bushes 70 can be elastically deformed and can absorb the expansion. Accordingly, even if loads caused by the expansion of the casing 20 are applied to the joint interface 23, the loads applied to the joint interface 23 caused by the expansion of the casing 20 can be reduced. Accordingly, the breakage of the joint interface 23 can be prevented.

According to the above embodiment, the following advantageous effects can be obtained.

1. In the above embodiment, the flow path forming device 10 includes the collar 80. The collar 80 is formed of a material having greater rigidity than the bush 70 and includes the tube 81 and the annular section 82. The collar 80 includes the tube 81 inserted into the bush 70, and the annular section 82 is positioned between the bush 70 and the screw S in the second direction D2.

The reasons why the flow path forming device 10 includes the collar 80 will be described. When the valve 30 is attached to the first case attachment section 212 with the screw S, the bush 70 is elastically deformed by a force of fastening the screw S and is compressed in a direction where the screw S is screwed, i.e., the second direction D2 in the present embodiment. Thus, if the flow path forming section 10 does not include the collar 80, it is difficult to set the position of the valve 30 in the second direction D2.

In this situation, the flow path forming device 10 of the present embodiment includes the collar 80. Even if the bush 70 is compressed in the second direction D2 by the force of fastening the screw S, the tube 81 stops the screw S being screwed. As a result, the collar 80 can limit the elastic deformation of the bush 70 in the second direction D2. In the present embodiment, the collar 80 serves as a deformation limitation section that limits the elastic deformation of the bush 70 in a direction crossing the first direction D1.

Accordingly, if the valve 30 is attached to the first case 21 and the second case 22 with the screw S inserted into the bushes 70, it is easy to set the position of the valve 30 in the second direction D2.

### Modification of the Second Embodiment

In the above described second embodiment, an example in which the flow path forming device 10 includes the collar 80 has been described, but the present disclosure is not limited to this example. For example, the flow path forming device 10 may not include the collar 80.

### Third Embodiment

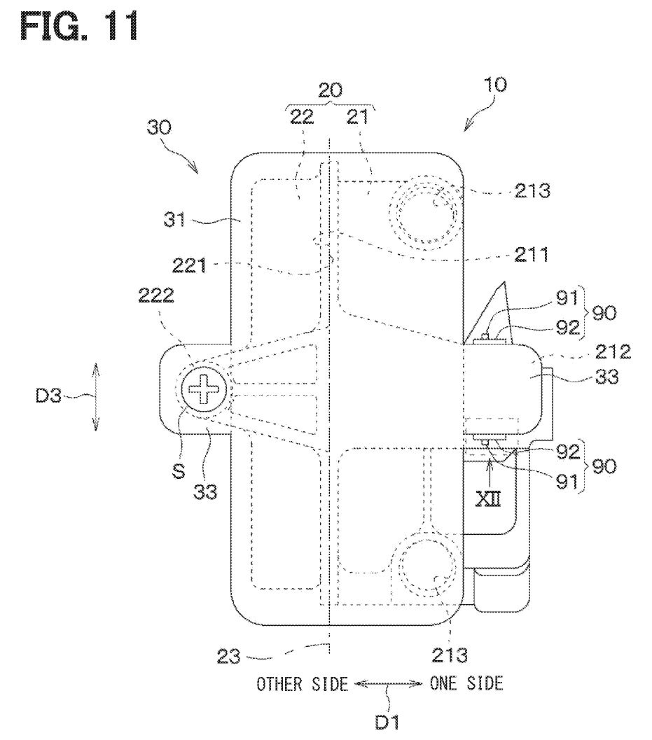

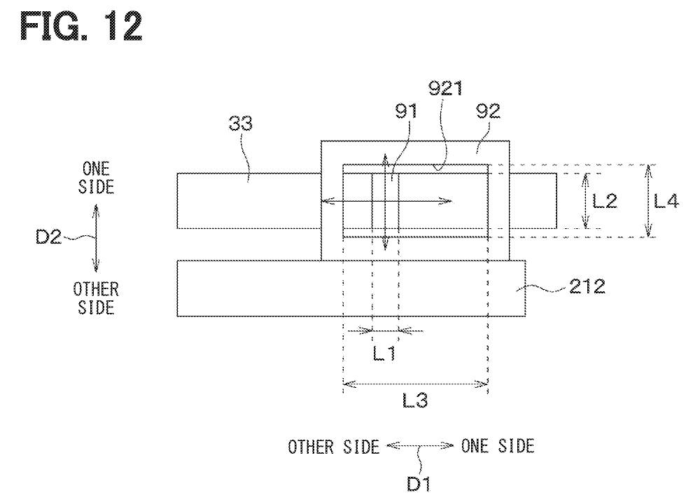

Next, a third embodiment will be described with reference to FIGS. 11 and 12. In the present embodiment, a structure in which a valve 30 is attached to a first case 21 is different from a structure of the first embodiment. The other configurations are the same as those of the first embodiment. Therefore, in the present embodiment, portions different from the first embodiment will be mainly described, and description of portions similar to the first embodiment may be omitted.

As shown in FIG. 11, a flow path forming device 10 includes two snap fits 90 where the valve 30 is attached to the first case 21. Each snap fit 90 includes a claw part 91, and an engagement part 92 in which the claw part 91 is fitted. The two snap fits 90 are positioned at opposite sides of a valve attachment section 33 in a third direction D3. This pair of snap fits 90 attaches the valve 30 to the first case 21 by the claw part 91 being fitted in the engagement part 92.

Each snap fit 90 of the present embodiment includes the claw part 91 positioned on the valve 30 and the engagement part 92 positioned on the first case 21. Each snap fit 90 may include the claw part 91 positioned on the first case 21 and the engagement part 92 positioned on the valve 30. Additionally, the valve 30 and a second case 22 are joined, using a screw S described in the first embodiment.

The claw parts 91 of the snap fits 90 are positioned on opposite surfaces of the valve attachment section 33 facing away from each other in the third direction D3. The valve attachment section 33 is positioned on one side of the valve 30 in a first direction D1. One of the claw parts 91 is provided on one side of the valve attachment section 33 in the third direction D3 and protrudes from the valve attachment section 33 in the third direction D3. Another of the claw parts 91 is provided on the other side of the valve attachment section 33 in the third direction D3 and protrudes from the valve attachment section 33 in the third direction D3. The claw parts 91 have triangular plate shapes whose size in the third direction D3 decreases toward the first case 21.

Engagement parts 92 of the snap fits 90 are provided on the first case attachment section 212 and face the claw parts 91 in a second direction D2, respectively. The two claw parts 91 are provided on opposite sides of the valve attachment section 33 in the third direction D3. The engagement parts 92 have, as shown in FIG. 12, thin rectangular plate shapes and protrude from the first case 212 toward the valve 30. Additionally, each engagement part 92 includes a fitting part 921 in which a claw part 91 is fitted. The fitting part 921 is an opening passing through the engagement part 92 in the third direction D3. The fitting part 921 seen along the third direction D3 is rectangular. The fitting part 921 has a size capable of accommodating the claw part 91 inside. Specifically, a size of the fitting part 921 in the first direction D1 is larger than a size of the claw part 91 in the first direction D1, and a size of the fitting part 921 in the second direction D2 is larger than a size of the claw part 91 in the second direction D2. The fitting part 921 seen along the third direction D3 may be trapezoidal.

Here, the size of the claw part 91 in the first direction D1 is referred to as a first claw length L1, the size of the claw part 91 in the second direction D2 is referred to as a second claw length L2, the size of the fitting part 921 in the first direction D1 is referred to as a first fitting length L3, and the size of the fitting part 921 in the second direction D2 is referred to as a second fitting length L4. The first fitting length L3 is larger than the first claw length L1 by an amount corresponding to an estimated error of a joint interface 23. Additionally, the second fitting length L4 is larger than the second claw length L2 by an amount corresponding to the estimated error of the joint interface 23.

Accordingly, even if the case hole distance CL deviates from its design value due to an error in the joint interface 23, such as a design error and an assembly error of the first joint face 211 and a second joint face 221, the amount of deviation from the design value can be absorbed by the size of the fitting section 921. As a result, even if the case hole distance CL deviates from the design value in the first direction D1, loads applied to the joint interface 23 due to the deviation can be reduced. Accordingly, the breakage of the joint interface 23 can be prevented.

Additionally, in the present embodiment, the second fitting length L4 is larger than the second claw length L2. As a result, a position of the valve 30 in the second direction D2 can be adjusted by using the fitting section 921.

### Modification of Third Embodiment

In the above third embodiment, an example has been described in which the valve 30 is attached to the first case 21 by the pair of snap fits 90 and to the second case 22 with the screw S. However, the present disclosure is not limited to this example. For example, the valve 30 may be attached to the first case 21 and the second case 22 by two pairs of snap fits 90, respectively.

### Other Embodiments

Although the representative embodiments of the present disclosure have been described above, the present disclosure is not limited to the embodiments and can be variously modified as follows, for example.

In the above embodiments, the example has been described in which the joint interface 23 is between the first joint face 211 and the second face 221, which are in plane shape and joined to each other. However, the present disclosure is not limited to this example. For example, a joint interface 23 may be formed by a first joint face 211 and a second joint face 221, one of which has a protruding shape, the other of which has a recessed shape, and which are fitted each other.

In the above embodiments, the example has been described, in which the flow path forming device 10 has a configuration in which the attachment position of the valve 30 in the first direction D1 is adjustable. However, the present disclosure is not limited to this example. A flow path forming device 10 may have a configuration in which an attachment position of a valve 30 in the first direction D1 is not adjustable.

In the above first embodiment, the inner diameter of a first valve hole 3311 is larger than the inner diameter of the first screw hole N11 by an amount corresponding to an error of the joint interface 23. Further, the example has been described in which the inner diameter of the second valve hole 3312 is larger than the inner diameter of the second screw hole N21 by an amount corresponding to the error of the joint interface 23. Additionally, in the above-described third embodiment, the example has been described, in which the first fitting length L3 is larger than the first claw length L1 by an amount corresponding to the error of the joint interface 23, and the second fitting length L4 is larger than the second claw length L2 by an amount corresponding to the error of the joint interface 23. However, the present disclosure is not limited to this example.

An inner diameter of the first valve hole 3311 may, regardless of the error of the joint interface 23, be larger than an inner diameter of a first screw hole N11 by a predetermined amount. Additionally, an inner diameter of the second valve hole 3312 may, regardless of the error of the joint interface 23, be larger than an inner diameter of the second screw hole N21 by a predetermined amount. The first fitting length L3 may, regardless of the error of the joint interface 23, be larger than the first claw length L1 by a predetermined amount. Additionally, the second fitting length L4 may, regardless of the error of the joint interface 23, be larger than the second claw length L2 by a predetermined amount.

In the above embodiments, the example has been described, in which the fluid flowing within the flow path of the flow path forming device 10 is the coolant. However, the present disclosure is not limited to this example. A fluid flowing within the flow path of the flow path forming device 10 may be, for example, a fluid other than the coolant such as a gas or an oil.

In the above embodiments, the example, in which the flow path forming device 10 is mounted in an electric automobile that is a vehicle, has been described. However, the present disclosure is not limited to this example. For example, the flow path forming device 10 may be applied to a vehicle with an internal combustion engine as a power source, or a fluid control system used in a factory or a house.

In the embodiments described above, it is needless to say that the elements constituting the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the shape, positional relationship, and the like, except for the case where it is specifically specified, the case where it is fundamentally limited to a specific shape, positional relationship, and the like.

What is claimed is:

1. A flow path forming device in which a fluid flows, comprising
three or more components, wherein
the three or more components include a first component, a second component and a third component,
the first component and the second component form a flow path within which the fluid flows,
the third component is attached to the first component and the second component,
the first component includes a first joint face joined to the second component,
the second component includes a second joint face joined to the first joint face,
the second component is joined to the first component by the second joint face being joined to the first joint face,
the third component is attached to the first component and the second component across a joint interface where the first joint face and the second joint face are joined to each other,
the flow path forming device further comprises:
a mounting adjustment section configured to adjust an attachment position of the third component in at least one of a surface normal direction and a direction crossing the surface normal direction, the surface normal direction being perpendicular to the joint interface; and
a snap fit with which the third component is attached to the first component and the second component,
the snap fit includes a claw part and an engagement part,
the engagement part includes a hollow fitting part where the claw part is fitted, and
the mounting adjustment section includes the snap fit, in which a size of the fitting part is larger than a size of the claw part by a predetermined amount in at least one of the surface normal direction and a predetermined direction crossing the surface normal direction.

2. The flow path forming device according to claim 1, wherein
the predetermined amount is determined based on an error of the joint interface where the first joint face and the second joint face is joined to each other.

3. A flow path forming device in which a fluid flows, comprising
three or more components, wherein
the three or more components include a first component, a second component and a third component,
the first component and the second component form a flow path within which the fluid flows,
the third component is attached to the first component and the second component,
the first component includes a first joint face joined to the second component,
the second component includes a second joint face joined to the first joint face,
the second component is joined to the first component by the second joint face being joined to the first joint face,
the third component is attached to the first component and the second component across a joint interface where the first joint face and the second joint face are joined to each other,
the flow path forming device further comprises a mounting adjustment section configured to adjust an attachment position of the third component in at least one of a surface normal direction and a direction crossing the surface normal direction, the surface normal direction being perpendicular to the joint interface,
the third component is attached to the first component and the second component with screws,
the mounting adjustment section includes elastic sections made of an elastic material and including elastic section holes where the screws are inserted,
central axes of the elastic section holes extend in a direction crossing the surface normal direction, and
the third component is attached to the first component and the second component with the screws inserted into the elastic section holes.

4. The flow path forming device according to claim 3, wherein
the mounting adjustment section includes deformation limiting sections configured to limit elastic deformation of the elastic sections in a direction crossing the surface normal direction.

5. A flow path forming device in which a fluid flows, comprising
three or more components, wherein
the three or more components include a first component, a second component and a third component,
the first component and the second component form a flow path within which the fluid flows,
the third component is attached to the first component and the second component,
the first component includes a first joint face joined to the second component,
the second component includes a second joint face joined to the first joint face,
the second component is joined to the first component by the second joint face being joined to the first joint face,
the third component is attached to the first component and the second component across a joint interface where the first joint face and the second joint face are joined to each other,
the flow path forming device further comprises a mounting adjustment section configured to adjust an attachment position of the third component in at least one of a surface normal direction and a direction crossing the surface normal direction, the surface normal direction being perpendicular to the joint interface,
the three or more components include
flow-path sections that allow a fluid to flow between the third component and the flow path formed by the first component and the second component,
flow-path insertion sections in which the flow-path sections are inserted, and
sealing members configured to prevent leakage of the fluid from between the flow-path sections and the flow-path insertion sections, and
the third component is attached to at least one of the first component and the second component through the flow-path sections.

6. The flow path forming device according to claim 1, wherein
the flow path forming device is mounted on a vehicle, and
the fluid is a coolant.
